(19) United States
(12) Patent Application Publication
(10) Pub. No.: US 2008/0232287 A1
(43) Pub. Date: Sep. 25, 2008

(54) Method and system for power saving scheduling in wireless local area networks

(75) Inventors: Huai-Rong Shao, San Jose, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon-City (KR)

(21) Appl. No.: 11/726,260

(22) Filed: Mar. 21, 2007

(51) Int. Cl. G08C 17/00

(52) U.S. Cl. 370/311

(57) ABSTRACT

A power saving (PS) scheduling process is provided for scheduling uplink and downlink frame transmissions between a PS transmitter and at least one PS receiver using PSAD sequences in a wireless communication system. The power saving scheduling process involves determining a power saving schedule of transmission opportunities for communication between a PS transmitter and at least one PS receiver over a shared channel, wherein the schedule includes corresponding durations for uplink transmissions of frames from each PS receiver to the PS transmitter. A Power Saving Aggregation Descriptor (PSAD) frame containing said schedule is constructed. A PSAD sequence is initiated by transmitting the PSAD from the PS transmitter to each PS receiver.

### FIELD OF THE INVENTION

The present invention relates to wireless networks, and in particular, to power saving for high throughput wireless local area networks (WLANs).

### BACKGROUND OF THE INVENTION

In many wireless communication systems, a frame structure is used for data transmission between a transmitter and a receiver. For example, the IEEE 802.11 standard uses frame aggregation in a Media Access Control (MAC) layer and a physical (PHY) layer. In a typical transmitter, a MAC layer receives a MAC Service Data Unit (MSDU) and attaches a MAC header thereto, in order to construct a MAC Protocol Data Unit (MPDU). The MAC header includes information such as a source address (SA) and a destination address (DA). The MPDU is a part of a PHY Service Data Unit (PSDU) and is transferred to a PHY layer in the transmitter to attach a PHY header (i.e., a PHY preamble) thereto to construct a PHY Protocol Data Unit (PPDU). The PHY header includes parameters for determining a transmission scheme including a coding/modulation scheme.

Many battery powered devices such as cellular phones and consumer electronic (CE) devices are being provided with the capability to access wireless networks such as high throughput wireless (e.g., radio frequency) local area networks (WLANs). As such, an efficient method of scheduling uplink and downlink frame transmissions over a shared channel at the access point (AP) is needed for power saving at power saving stations (e.g., the battery powered devices).

There are two approaches for a wireless station (STA) to access a shared wireless communication channel in a WLAN. One approach is a contention-free arbitration (CF) method. The other approach is a contention-based arbitration (CB) method. The CF access method utilizes a point coordinator function (PCF) to control access to the channel. When a PCF is established, the PCF polls registered STAs for communications and provides channel access to the STAs based polling results. The CB access method utilizes a random back off period to provide fairness in accessing the channel. In the CB period, a STA monitors the channel. If the channel has been silent for a pre-defined period of time, the STA waits a certain period of time, such that if the channel remains silent, the STA transmits on the channel.

Power Save Aggregation (PSA) is a mechanism for scheduling transmission opportunities over a shared channel, which employs a power saving aggregation descriptor (PSAD) frame. FIG. 1 illustrates the format of a conventional PSAD control frame 10 (described in IEEE Wireless LAN Edition (2003), “A compilation based on IEEE Std 802.11™—1999 (R2003) and its amendments,” incorporated herein by reference). The PSAD frame is a MAC control frame that provides a schedule of transmission opportunities (TXOP) to be used by a PSAD transmitter and PSAD receivers. The scheduled TXOPs begin immediately subsequent to the transmission of the PSAD frame. A high throughput (HT) station that is capable of using PSAD information indicates such capability in the PSAD frame. In an IEEE WLAN, such as IEEE 802.11, the PSAD frame is sent by the PSAD transmitter (i.e., an AP) to schedule both downlink and uplink transmissions between the AP and PSAD receivers (i.e., the PS stations).

The PSAD frame 10 has a MAC header that includes the following subfields: Frame Control and Duration 12, a Receiver Address (RA) 14, a Transmitter Address (TA) 16 and a Basic Service Set Identifier (BSSID) 18. A More PSAD Indicator bit 19 specifies whether there will be another PSAD sequence following a current PSAD sequence. A Descriptor End field 17 specifies the duration of the current PSAD sequence. The value of the sequence duration is an integer number of two Orthogonal Frequency-Division Multiplexing (OFDM) symbols (i.e., 8 μs). A STA ID field 15 specifies the station ID of a station associated to the AP. A down link transmission (DLT) Start Offset field 13 indicates the start of a DLT for a station relative to the end of the PSAD frame. The DLT offset is provided as an integer number of ½ OFDM symbols (i.e., 2 μs). If no DLT is scheduled for a station, but an uplink transmission (ULT) is scheduled for that station, then the DLT Start Offset field 13 is set to null (0).

Further, the DLT duration field 11 indicates the length of a DLT for a station. The DLT duration field 11 is based on a number of ½ OFDM symbols. If no DLT is scheduled for a station, but a ULT is scheduled for that station, then the DLT Duration 11 is set to null (0). A ULT Start Offset field 20 indicates the start of the ULT. The first ULT is scheduled to begin after a short interframe space (SIFS) interval from the end of the last DLT described in the PSAD. The ULT Start Offset is based on an integer number of ½ OFDM symbols (i.e., 2 us). If no ULT is scheduled for a station, but a DLT is scheduled for that station, then the ULT Start Offset 20 is set to null (0). A ULT Duration field 21 indicates the length of a ULT for a station. The ULT Duration is based on a number of ½ OFDM symbols. If no ULT is scheduled for a station, but a DLT is scheduled for that station, then the ULT Duration 21 is set to null (0). A station cannot use the medium longer than the time allocated in the PSAD frame.

FIG. 2 shows the timing structure of a PSAD sequence 25. The PSAD frame 10 (which includes receiving station IDs, ULT and DLT offsets and durations) from the AP provides information to each station (e.g., STA₁, . . . , STAₙ) regarding the time-positions of corresponding frames. This allows each station to recognize the time-position of its frames 14.

However, in such existing power saving approaches using PSAD, the AP has no knowledge of the durations of uplink data frames from power saving (PS) stations. Though some approaches using traffic specification (TSPEC) provide the time, maximal and nominal length of frames in a data stream, nevertheless not all frames from PS stations are associated with a TSPEC. Even with a TSPEC, the AP has no knowledge of the actual sizes of the uplink frames with variable sizes, in order to properly reserve a shared channel for those transmissions.

If the AP overestimates the ULT duration, throughput performance will be degraded since the shared channel remains reserved for longer than needed, and idles unnecessarily. If the AP underestimates the ULT duration, then PS stations experience buffer overflow. Further, Quality of Service (QoS) performance will be negatively affected. For example, delay and delay jitter will be increased. Moreover, conventional PSAD approaches do not specify PSAD utilization in the Contention-Free Period (CFP) and the Contention Period (CP) of transmission.

There is, therefore, a need for a method and system to schedule uplink and downlink traffic for both PS and non-PS stations.

### BRIEF SUMMARY OF THE INVENTION

The present invention provides a power saving (PS) scheduling method and system for scheduling uplink and downlink frame transmissions between a PS transmitter and at least one PS receiver using PSAD sequences in a wireless communication system.

In one embodiment, such power saving scheduling involves determining a power saving schedule of transmission opportunities for communication between a PS transmitter and at least one PS receiver over a shared channel, wherein the schedule includes corresponding durations for uplink transmissions of frames from each PS receiver to the PS transmitter; constructing a Power Saving Aggregation Descriptor (PSAD) frame containing said schedule; and initiating a PSAD sequence by transmitting the PSAD from the PS transmitter to each PS receiver.

The PS transmitter precisely schedules uplink and downlink transmission times for each PS receiver using uplink information from each PS receiver without polling the receivers. The PS transmitter notifies the PS receivers to provide such uplink information using signaling in PSAD frames transmitted to the PS receivers.

Precise duration for uplink traffic with variable frame sizes is allocated to achieve high efficiency of channel utilization. Therefore, the PS receivers enter lengthier sleep cycles in order to save more power and transmission bandwidth.

These and other features, aspects and advantages of the present invention will become understood with reference to the following description, appended claims and accompanying figures.

### BRIEF DESCRIPTION OF THE DRAWINGS

FIG. 1 illustrates the format of a conventional PSAD control frame.

FIG. 2 shows the structure of a conventional PSAD sequence.

FIG. 3 shows a modified PSAD frame, according to an embodiment of the present invention.

FIG. 4 shows the format of a Next Frame Notice (NFN) control frame, according to an embodiment of the present invention.

FIG. 5 shows an example of a PSAD sequence as Piggyback, according to an embodiment of the present invention.

FIG. 6 shows the structure and the sequence of a CFP and CP channel access with PSAD, according to an embodiment of the present invention.

FIG. 7A shows a flowchart of example scheduling procedures with PSAD and NFN at stations, according to an embodiment of the present invention.

FIG. 7B shows a flowchart of another example of scheduling procedures with PSAD and NFN at stations, according to an embodiment of the present invention.

FIG. 8 shows an example partitioning structure for traffic from/to non-PS and PS stations in the CFP with PSAD, according to an embodiment of the present invention.

FIG. 9 shows a block diagram of an example WLAN system, implementing a power saving scheduling mechanism according to an embodiment of the present invention.

FIG. 10 shows an example protocol architecture for the AP and the STAs in FIG. 9, which implement a power saving scheduling mechanism, according to an embodiment of the present invention.

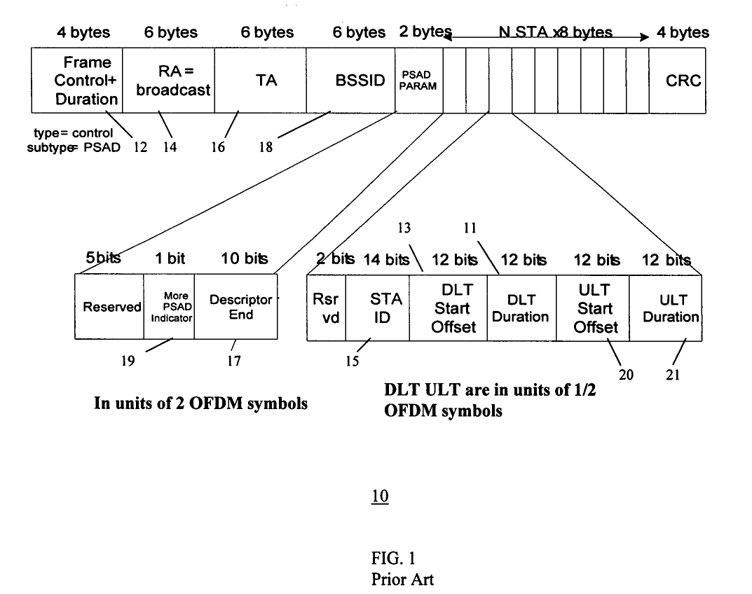

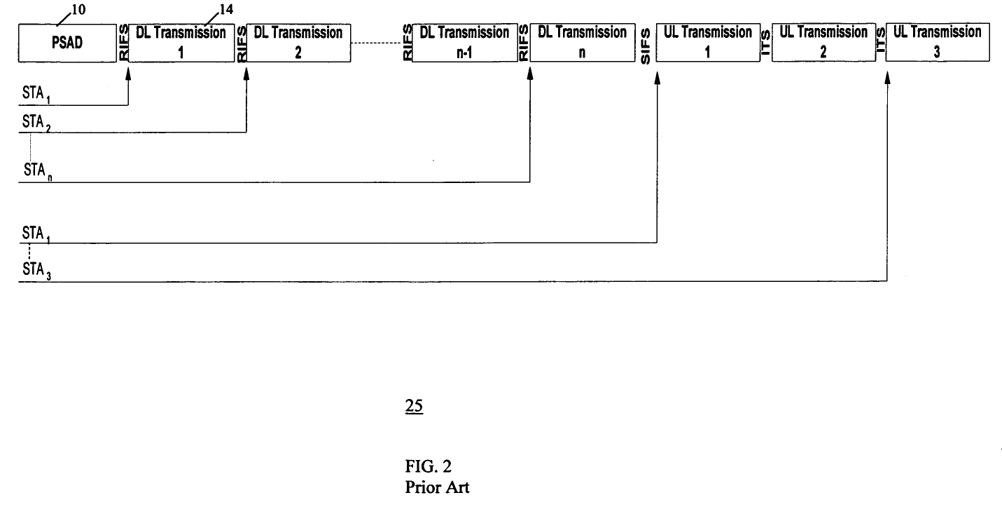

### DETAILED DESCRIPTION OF THE INVENTION

The present invention provides a power saving scheduling mechanism for access to a shared channel in wireless networks such as WLANs. In one implementation, this involves scheduling uplink and downlink frame transmissions at an AP within the WLAN, with an objective of power saving. In addition, transmission traffic from/to PS stations and non-PS stations in the WLAN, is partitioned so that PS stations can reduce power (e.g., enter a power saving state or a sleep cycle) when traffic for non-PS stations is transmitted. The AP separates and schedules the traffic from/to PS and non-PS stations at different channel periods. During a channel period allocated for transmission traffic from/to non-PS stations, all PS stations can enter a sleep cycle. This provides the PS stations with longer time sleep cycles, and without frequent switches between active cycles and sleep cycles.

The AP is enabled to precisely schedule uplink and downlink transmission times for each PS station using two control frames: a modified PSAD frame and a newly defined next frame notice (NFN) frame. This allows for the allocation of precise durations for uplink traffic with variable frame sizes to achieve high efficiency channel utilization. In addition, PS stations can enter sleep cycles for as long as possible in order to save more power.

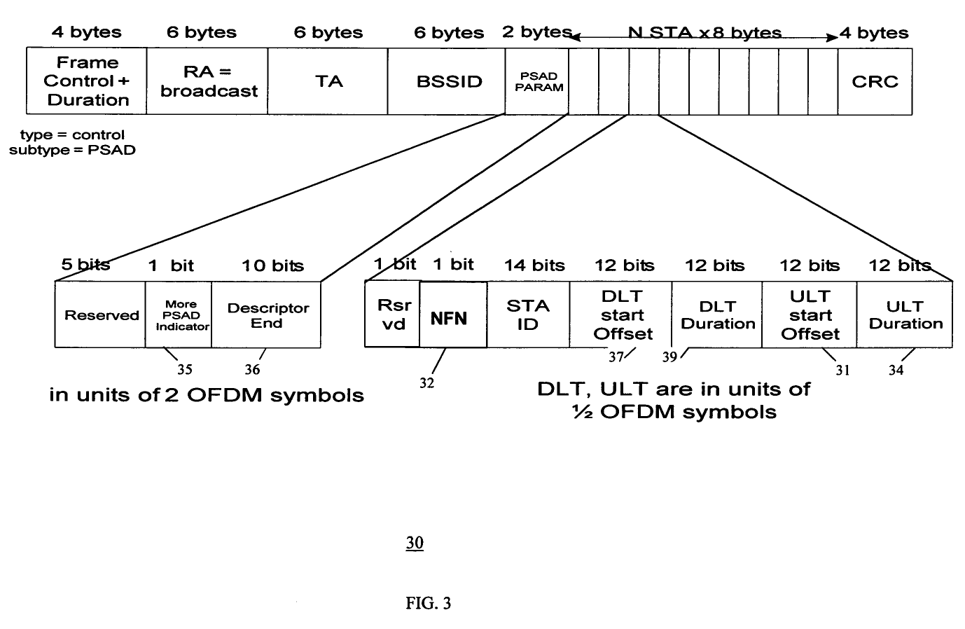

FIG. 3 shows a modified PSAD frame 30 according to an embodiment of the present invention, wherein a NFN indicator 32 (e.g., one reserved bit from PSAD reserved bits) provides a NFN for a corresponding STA. Other and/or additional fields and/or bits in the PSAD frame may be used for the NFN indication as well.

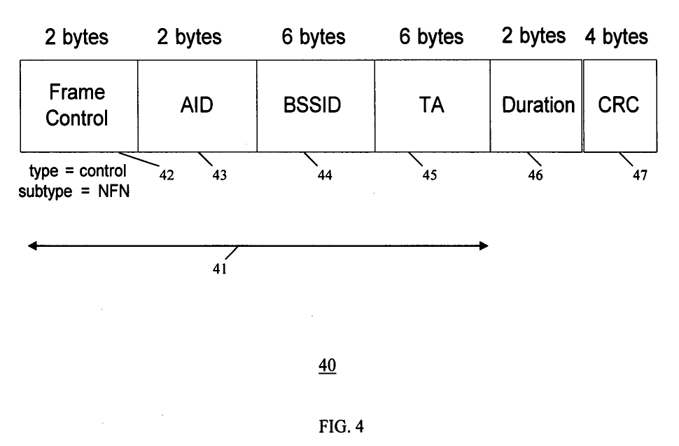

The NFN indicator 32 is used to indicate whether the ULT Start Offset and ULT Duration of the corresponding STA are to specify the uplink transmission of a NFN control frame from a station to the AP. FIG. 4 shows the format of a NFN control frame 40, according to an embodiment of the present invention. The NFN control frame 40 is used by a station to inform the AP of the duration of a frame pending at the head of the station's transmission queue. The NFN control frame 40 has a MAC header 41 including the following fields: a Frame Control 42, an Association ID (AID) 43, a Transmitter Address (TA) 45, and a Basic Service.Set Identifier (BSSID) 44. The subfields 42-45 can be as described in the IEEE Wireless LAN Edition (2003), “A compilation based on IEEE Std 802.11™—1999 (R2003) and its amendments,” incorporated herein by reference.

As shown in FIG. 4 according to the present invention, the NFN control frame 40 further includes a Duration field 46 as a payload including 2 bytes and a CRC field 47. The Duration field 46 indicates the duration of a frame pending at the head of the station's transmission queue. The Duration field 46 is based on an integer number of ½ OFDM symbols (e.g., 2 μs). The total length of the NFN control frame 40 is 22 bytes.

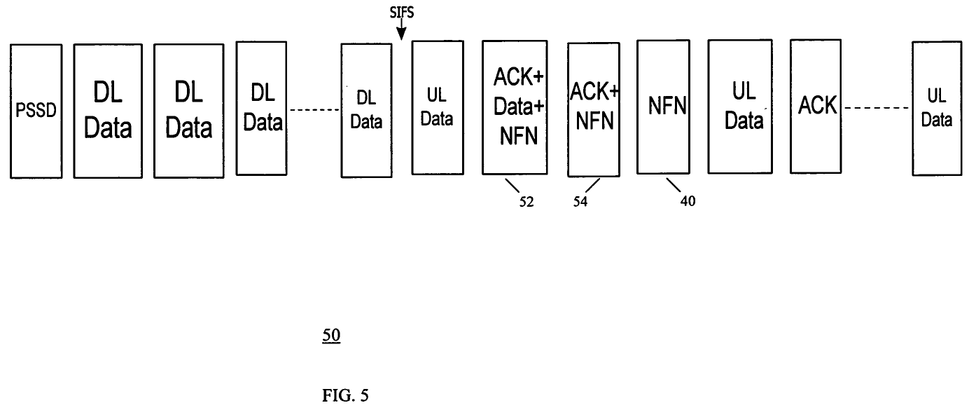

As shown by the example communication sequence 50 in FIG. 5, an NFN control frame 40 can be transmitted from a station to the AP separately, or piggybacked or aggregated with other uplink data 52 or control frames such as an ACK 54, transmitted from a station to the AP.

Power saving is achieved by replacing the conventional polling for a CFP for channel access, with a scheduling mechanism based on modified PSAD frames 30 (FIG. 3) and NFN control frames 40 (FIG. 4). After a SIFS interval past a beacon signal, a CFP for channel access begins. During the CFP period, the AP (the PSAD transmitter) sends out the first modified PSAD frame 30 to PS stations (the PSAD receivers) to initiate a PSAD sequence. The modified PSAD frame 30 provides information to each PS station regarding the time and location of PPDUs in a PSAD sequence. This allows a PS station to recognize the position of its PPDU frames by only reading the modified PSAD frame 30, and implement power saving by subsequently waking up only at the time-positions necessary to receive its frames. Additionally, the modified PSAD 30 can provide uplink transmission scheduling for any expected response or reverse data flow from the receiving PS stations. The uplink schedule is conveyed using the ULT Start Offset values in the modified PSAD frame 30.

The AP determines the precise duration of each data frame for uplink traffic from a PS station to the AP. When the AP has TSPEC information of an uplink flow, and constant frame sizes and constant bit rates are used by that flow, then the AP can specify ULT Start Offset 31 and ULT Duration 34 in the modified PSAD frame 30.

If the uplink flow is variable in frame size or there is no TSPEC information for that uplink traffic at the AP, then the AP cannot specify the precise value for the ULT Duration 34, without more. However, by transmitting a NFN control frame 40 to the AP, a PS station can inform the AP of the expected transmission duration of the next uplink frame (i.e., the frame pending at the head of the transmission queue for transmission to the AP next).

Accordingly, for each PS station in the AP's polling list, if the AP can determine the precise ULT Duration 34 for the next uplink frame with TSPEC information, then the AP sets the ULT Duration value in the PSAD frame 30; otherwise, the AP sets the ULT Duration 34 as the transmission time of a NFN control frame 40 to require that PS station to inform the AP of the duration of the next uplink frame from the PS station.

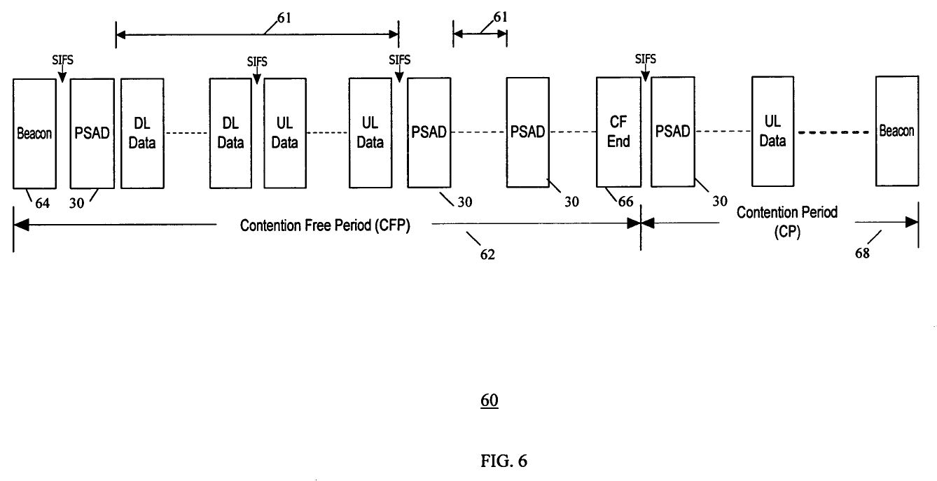

FIG. 6 illustrates an example PSAD sequencing 60 for channel access during a CFP and a CP, according to an embodiment of the present invention. A CFP 62 begins a SIFS period after a beacon signal 64. There can be multiple PSAD sequences 61 within one CFP, wherein each PSAD sequence begins with the transmission of a modified PSAD frame 30 from the AP. During a CFP, downlink data from the AP to PS stations and non-PS stations are partitioned into different PSAD sequences. A first modified PSAD frame 30 is transmitted a SIFS interval after a beacon signal starts a CFP. After receipt of a PSAD frame 30 that initiates a PSAD sequence, a PS station can schedule its own sleep (power save) and wake (active) cycles during that PSAD sequence. The transmission times of subsequent PSAD frames can be calculated from the sequence duration field of a previous PSAD.

If the last PSAD sequence completes before the maximum duration of the CFP (i.e., CFPMaxDuration), the AP transmits a CF-end frame 66 to complete the CFP period 62. The More PSAD indicator field 35 (FIG. 3) in the last PSAD frame 30 transmitted by the AP during the CFP 62, informs the stations whether to expect a PSAD sequence at the beginning of a CP 68 that follows the CFP 62. Therefore, if the AP wishes to send one or more frames to the PS stations during the CP 68, then during the CFP 62 the AP sends a last PSAD frame 30 with the More PSAD indicator field 35 set to indicate to the receiving stations to expect a PSAD sequence at the start of the CP 68 following the CFP 62. After the last PSAD sequence in the interval spanning the CFP 62 and the CP 68, all of the PS stations can enter a sleep cycle until the start of the next CFP.

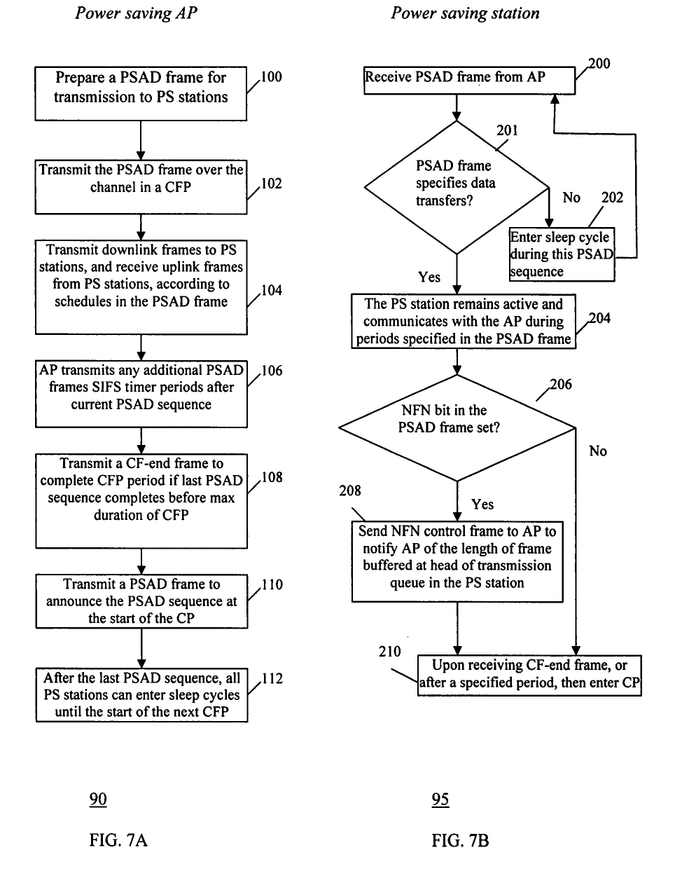

Now also referring to the flowcharts in FIGS. 7A-B, an example of a channel access scheduling processes 90, 95, using the modified PSAD frame 30 (FIG. 3) and NFN frame 40 (FIG. 4), according to an embodiment of the present invention, is now described. The example channel access scheduling processes 90 in FIG. 7A is implemented by a power saving AP (PSAD transmitter) and the scheduling process 95 in FIG. 7B is implemented in one or more PS stations (PSAD receivers) in a WLAN, according to the following steps:

At the power saving AP side (FIG. 7A):
Step 100: The AP prepares a modified PSAD frame 30 (FIG. 3) for transmission to PS stations over a channel. The information in the PSAD frame 30 is based on: the AP's transmission queue occupation, TSPEC information of PS stations in the AP's polling list, and NFN information fed back from PS stations. If the AP decides to send another PSAD frame after the current PSAD frame, the AP sets the More PSAD indicator field 35 in the current PSAD frame 30 to “1.” For each PS station in the AP's polling list, if the AP cannot obtain any information about the uplink traffic from the PS station, then the AP sets the NFN bit 32 in the current PSAD frame 30 to “1” and specifies' the ULT Duration 34 as the length of transmitting a NFN control frame 40 from a PS station.
Step 102: The AP transmits the PSAD frame 30 over the channel in a CFP.
Step 104: The AP transmits downlink frames to PS stations over the channel during DLT intervals (scheduled by the DLT Start Offset 37 and DLT Duration 39) in the PSAD frame 30. Further, the AP receives uplink frames from the PS stations during scheduled ULT intervals (scheduled by the ULT Start Offset 31 and ULT Duration 34) in the PSAD frame 30.
Step 106: If additional PSAD frames are to be transmitted, the AP transmits the additional PSAD frames a SIFS interval after the current PSAD sequence. If delay and jitter requirements allow, the AP schedules downlink and uplink traffic for PS stations and non-PS stations in different PSAD sequences.
Step 108: If the last PSAD sequence completes before the maximum duration of the CFP (CFPMaxDuration), the AP sends out a CF-end frame to complete the CFP period. The More PSAD indicator field 35 of the last PSAD frame during the CFP informs the PS stations whether there is a PSAD (or otherwise), at the beginning of the following CP.
Step 110: Optionally, if the AP wishes to transmit additional downlink frames to PS stations during the CP, then the AP transmits a PSAD frame to announce the PSAD sequence at the start of the CP.
Step 112: After the last PSAD sequence in the interval spanning the CFP and CP, all PS stations can enter sleep (power saving) cycles until the start of the next CFP.

At a power saving station side (FIG. 7B):
Step 200: PS station receives a PSAD frame 30 from the PA over the channel.
Step 201: The PS station checks if the PSAD frame 30 specifies ULT and DLT data transfer schedules for the PS station. If none are scheduled, then proceed to step 202, otherwise proceed to step 204.
Step 202: The PS station enters a sleep cycle during the current PSAD sequence.
Step 204: The PS station remains active to receive or transmit data frames during the periods specified by the PSAD frame, and sleeps during other periods.
Step 206: The PS station determines if the NFN bit in the received PSAD frame 30 set to “1” for the PS station? If yes, proceed to step 208, otherwise transmit uplink data frames to AP as scheduled, and proceed to step 210.
Step 208: Instead of sending an uplink data frame, the PS station checks its uplink queue status (e.g., to obtain: the precise length of the frame at the head of its transmission queue, number of frames in the queue, queue buffer remaining free, etc.), and constructs and transmits a NFN control frame 40 (FIG. 4) to the AP during a scheduled ULT period. The NFN control frame 40 notifies the AP of the length of the frame at the head of the queue in the PS station. Using the information carried in the NFN frame 40, the AP can specify the precise uplink data duration for this PS station in a next PSAD frame 30.
Step 210: After a PS station receives a CF-end frame from the AP, or when a CFPMaxDuration time passes without receiving a CF-end, the PS station enters the CP. If the PS station does not receive PSAD frames at the start of the CP, then the PS station enters a sleep cycle until the start of the next CFP.

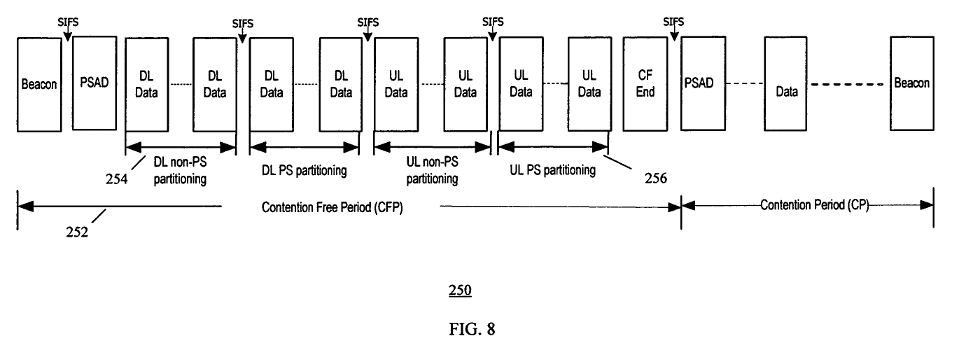

FIG. 8 shows an example partitioning structure 250 for traffic from/to non-PS and PS stations in a CFP 252, according to an embodiment of the present invention. Transmission traffic from/to PS and non-PS stations is partitioned such that PS stations can reduce power (e.g., sleep) when traffic for non-PS stations is transmitted over the channel. The AP separates and schedules the traffic from/to PS and non-PS stations at different channel periods. During channel periods 254 for transmission of traffic from/to non-PS stations, all PS stations can enter a sleep state. During channel periods 256 for transmission of traffic from/to PS stations, the involved PS station(s) remain active. With the partitioning scheme, the PS stations are provided with longer sleep cycles without frequent switches between active and sleep states.

The present invention is applicable to wireless networks in general, examples of which include WLAN, wireless personal area network (WPAN), wireless metropolitan area network (WMAN), different kinds of cellular networks, etc.

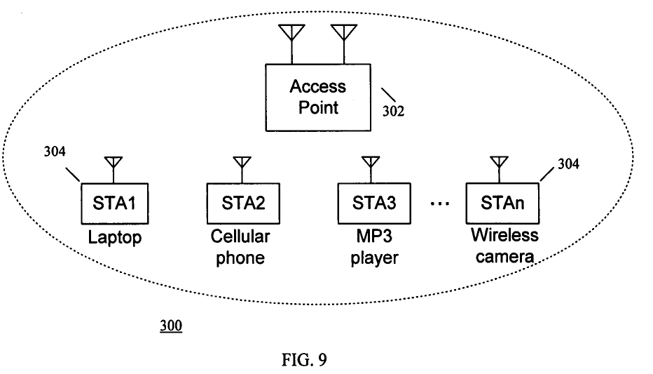

FIG. 9 shows a block diagram of an example WLAN system 300 implementing a power saving scheduling mechanism according to an embodiment of the present invention. The system 300 includes an access point (AP) 302 and n stations (STAs) 304, wherein some stations such as a cellular phone and a wireless camera are PS STAs. In the presence of an AP, usually STAs do not communicate with one another directly if the WLAN works at the infrastructure mode. All frames are transmitted to the AP, and the AP transmits them to their destined STAs. Since the AP is forwarding all frames, the STAs are no longer required to be in range of one another. The only requirement is that the STAs be within range of the AP. In FIG. 9, as an example, if STA 1 sends a frame to STA 2, STA 1 first sends the frame to the AP, and the AP forwards the frame to STA 2. The radio medium is shared among different stations and the APs using an algorithm called Carrier Sense Multiple Access with Collision Avoidance (CSMA/CA) during the contention Period (CP).

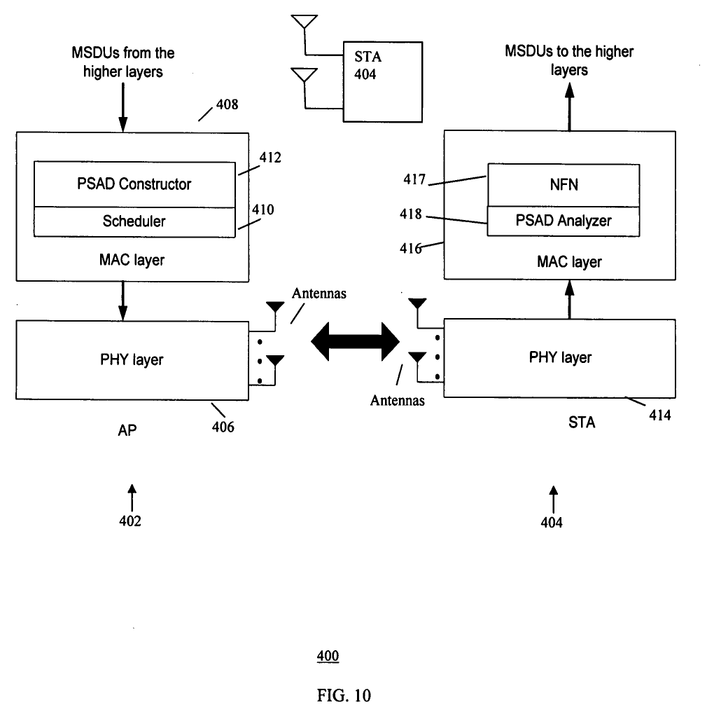

FIG. 10 shows an example protocol architecture 400 for the PS AP and the PS STAs in FIG. 9, which implements a power saving scheduling mechanism, according to an embodiment of the present invention. The protocol architecture 400 includes a PS AP 402 and one or more PS STAs 404. The AP 402 comprises a physical (PHY) layer 406, and a media access control (MAC) layer 408. The PHY layer 406 implements a type of IEEE 802.11 communication standard for transmitting data over a channel. The MAC layer 408 comprises a scheduler function 410 and a PSAD constructor 412. The scheduler function 410 provides schedules for downlink and uplink transmissions, and the PSAD constructor 412 constructs PSAD frames including such schedules.

Each STA 404 includes a PHY layer 414 corresponding to the PHY layer 406 of the AP 402. Each STA further includes a MAC layer 416 that comprises a PSAD analyzer 418 and a NFN module 417. The PSAD analyzer 418 analyzes received PSADs for managing scheduled communications with the AP 402. The NFN module 417 generates NFN control frames 40 for transmission to the AP 402. The scheduler function 410, the PSAD constructor 412, the PSAD analyzer 418 and the NFN module 417 are logical modules, which implement an example of the power saving mechanism according to the present invention, as described.

Although in the description of FIG. 10 the STAs and the AP have been shown separately, each is a type of wireless communication station capable of transmitting and/or receiving over a wireless channel in a wireless communication system such as a WLAN. Therefore, a wireless communication station herein can function as a transmitter, a receiver, an initiator and/or a responder. It then follows that an AP can function as a transmitter, a receiver, an initiator and/or a responder. Similarly, a STA can function as a transmitter, a receiver, an initiator and/or a responder.

As such according to the present invention, transmissions in a CFP are completely scheduled with PSAD and NFN frames, eliminating the need for an IEEE 802.11 PCF polling mechanism in the CFP. Traffic sent to PS stations and non-PS stations can be partitioned so that PS stations can have more sleep time. Using NFN frames fed back from the PS stations, the AP can specify precise ULT Durations in a PSAD to avoid channel bandwidth idling and waste. During a CFP, fine granular power saving scheduling can be performed using multiple PSADs. Several approaches for feedback of NFN frame information to the AP can be utilized including, for example, a NFN control frame format, QoS control field in the MAC header, piggyback with other frames, etc.

Compared to the conventional approaches, the present invention provides PS stations more time to sleep, and improves transmission efficiency by precisely scheduling frame transmission. The AP can assign precise ULT durations because stations can feedback the actual frame sizes of the uplink traffic using NFN frames 40. This further allows power saving for PS stations whose traffic flows have no TSPEC to specify traffic characteristics.

Alternatively, the need for transmission of a NFN frame 40 from a PS receiver to the PS transmitter can be automatically detected by the PS receiver without relying on a NFN field 32 in a PSAD. The PS transmitter can use other ways of notifying a PS receiver of the need for transmitting a NFN frame 40 to the PS transmitter. Because an NFN frame 40 has a predetermined fixed length (e.g., 22 bytes), in one example a PS AP calculates a ULT duration for a NFN frame 40 based modulation and coding rate of an uplink transmission from a PS STA. The PS AP schedules a ULT duration in a conventional PSAD 10 for transmission of such a NFN frame 40 from that PS STA, and transmits the PSAD 10. Then, the PS STA checks its assigned ULT duration in the received PSAD 10, and if that ULT duration matches the uplink transmission time needed for transmission of a NFN frame 40, then the PS STA detects that the PS AP needs a NFN frame 40 from the PS STA (indicating length of next uplink frame from the PS STA). In that case, the PS STA transmits a NFN frame 40 to the PS AP during a scheduled uplink transmission period. Using such auto-detection, the conventional PSAD frame 10 can be used instead of the modified PSAD frame 30 to notify a PS STA of the need for a NFN control from 40, according to an alternative power saving scheduling mechanism according to the present invention. A power saving station includes a device in which power consumption is reduced.

As is known to those skilled in the art, the aforementioned example architectures described above, according to the present invention, can be implemented in many ways, such as program instructions for execution by a processor, as logic circuits, as an application specific integrated circuit, as firmware, etc.

The present invention has been described in considerable detail with reference to certain preferred versions thereof; however, other versions are possible. Therefore, the spirit and scope of the appended claims should not be limited to the description of the preferred versions contained herein.

What is claimed is:

1. A power saving (PS) scheduling method for communication in a wireless network, comprising the steps of:
determining a power saving schedule of transmission opportunities for communication between a PS transmitter and at least one PS receiver over a shared channel, wherein the schedule includes corresponding durations for uplink transmissions of frames from each PS receiver to the PS transmitter;
constructing a Power Saving Aggregation Descriptor (PSAD) frame containing said schedule; and
initiating a PSAD sequence by transmitting the PSAD from the PS transmitter to each PS receiver.

2. The method of claim 1 wherein the step of determining a power saving schedule further includes the steps of:
determining a downlink (DL) schedule for downlink transmissions (DLT) from the PS transmitter to each PS receiver; and
determining an uplink (UL) schedule for uplink transmissions (ULT) from each PS receiver to the PS transmitter, wherein the uplink schedule includes precise durations for uplink transmissions of variable size frames from each PS receiver to the PS transmitter.

3. The method of claim 1 wherein:
the network includes at least one non-PS receiver;
the step of determining a power saving schedule further includes the step of partitioning downlink transmissions from the PS transmitter to each PS receiver and each non-PS receiver into different PSAD sequences; and
the method further including the steps of, each PS receiver entering a power saving cycle during scheduled transmissions for non-PS receivers.

4. The method of claim 1 further comprising the steps of:
receiving a PSAD from the PS transmitter at a PS receiver;
analyzing the schedule in the PSAD; and
if the PSAD does not specify a schedule for this receiving PS receiver, then entering a power saving cycle, otherwise communicating with the PS transmitter according to a corresponding schedule in the PSAD.

5. The method of claim 1 further comprising the steps of:
receiving the PSAD from the PS transmitter at a PS receiver;
analyzing the schedule in the received PSAD; and
providing uplink transmission information to the PS transmitter based on signaling in the PSAD, by:
determining an indication of the length of an uplink frame for a next uplink transmission from the PS receiver to the PS transmitter; and
transmitting the indication of length of said uplink frame to the PS transmitter.

6. The method of claim 2 further comprising the steps of:
receiving the indication of the length of said uplink frame from the PS receiver; and
based on the indication of the length of said uplink frame, scheduling a precise duration for uplink transmission of said uplink frame from the PS receiver in a subsequent PSAD sequence.

7. The method of claim 5 wherein:
the step of constructing a PSAD further comprises the step of including a next frame notice in the PSAD for a PS receiver, to notify that PS receiver to provide an indication of the length of a subsequent uplink frame for uplink transmission from that PS receiver to the PS transmitter.

8. The method of claim 7 wherein:
the step of analyzing the schedule in the received PSAD further includes the step of checking for a next frame notice in the PSAD for this PS receiver; and
the step of providing uplink transmission information to the PS transmitter further includes the step of providing the uplink transmission information if the PSAD includes such a next frame notice for this PS receiver.

9. The method of claim 7 wherein the step of providing uplink transmission information to the PS transmitter further includes the step of transmitting the indication of length of said uplink frame to the PS transmitter in a control frame.

10. The method of claim 7 wherein the next frame notice indicates whether an ULT Start Offset and an ULT Duration in the PSAD for uplink transmission by the PS receiver describe the uplink transmission of said control frame.

11. The method of claim 5 wherein:
the step of constructing a PSAD further comprises the step of including a pre-specified uplink transmission duration in the PSAD for a PS receiver, to notify that PS receiver to provide an indication of the length of a subsequent uplink frame for uplink transmission from that PS receiver to the PS transmitter

12. The method of claim 11 wherein:
the step of analyzing the schedule in the received PSAD further includes the step of checking for a next frame notice in the PSAD for this PS receiver; and
the step of providing uplink transmission information further includes the step of providing the uplink transmission information if the PSAD includes such a next frame notice for this PS receiver.

13. The method of claim 12 wherein the step of providing uplink transmission information to the PS transmitter further includes the step of transmitting the indication of length of said uplink frame to the PS transmitter in a control frame to the PS transmitter.

14. The method of claim 13 wherein said pre-specified uplink transmission duration indicates a pre-specified length of said control frame length of 22 bytes.

15. The method of claim 14 wherein said pre-specified length is 22 bytes.

16. The method of claim 1 wherein the wireless network comprises a wireless local area network (WLAN).

17. The method of claim 16 wherein the transmitter comprises an access point and each receiver comprises a station.

18. A wireless communication system comprising:
a power saving (PS) transmitter and at least one PS receiver, configured to communicate a wireless channel; and
the PS transmitter comprising:
a scheduler that is configured to determine a power saving schedule of transmission opportunities for communication between a PS transmitter and at least one PS receiver over a shared channel, wherein the schedule includes corresponding durations for uplink transmissions of frames from each PS receiver to the PS transmitter;
a Power Saving Aggregation Descriptor (PSAD) constructor that is configured to construct a PSAD frame containing said schedule; and
a transmission module that is configured to transmit the PSAD frame, thereby initiating a PSAD sequence for communication between the PS transmitter and each PS receiver.

19. The system of claim 18 wherein the scheduler is further configured to:
determine a DL schedule for DLT from the PS transmitter to each PS receiver;
determine an UL schedule for ULT from each PS receiver to the PS transmitter, wherein the uplink schedule includes precise durations for uplink transmissions of variable size frames from each PS receiver to the PS transmitter.

20. The system of claim 18 further including at least one non-PS receiver, wherein the scheduler is further configured to determine a power saving schedule that partitions downlink transmissions from the PS transmitter to each PS receiver and each non-PS receiver into different PSAD sequences, such that each PS receiver is further configured to enter a power saving cycle during scheduled transmissions for non-PS receivers.

21. The system of claim 18 wherein each PS receiver comprises:
a receiving module that is configured to receive a PSAD from the PS transmitter; and
a PSAD analyzer that is configured to analyze the schedule in the PSAD, and if the received PSAD does not specify a schedule for this receiving PS receiver, then enter the PS receiver into a power saving cycle, otherwise communicate with the PS transmitter according to a corresponding schedule in the PSAD.

22. The system of claim 18 wherein the PS receiver comprises:
a receiving module that is configured to receive a PSAD from the PS transmitter; and
a PSAD analyzer that is configured to analyze the schedule in the PSAD and provide uplink transmission information to the PS transmitter by:
determining an indication of the length of an uplink frame for a next uplink transmission from the PS receiver to the PS transmitter; and
transmitting the indication of length of said uplink frame to the PS transmitter.

23. The system of claim 19 wherein the scheduler is further configured to schedule a precise duration for uplink transmission of said uplink frame from the PS receiver in a subsequent PSAD sequence, based on the indication of the length of said uplink frame from the PS receiver.

24. The system of claim 22 wherein the PSAD constructor is further configured to include a next frame notice in the PSAD for a PS receiver, to notify that PS receiver to provide an indication of the length of a subsequent uplink frame for uplink transmission from that PS receiver to the PS transmitter.

25. The system of claim 24 wherein:
the PSAD analyzer is further configured to check for a next frame notice in the received PSAD, for this PS receiver, and provide uplink transmission information to the PS transmitter if the PSAD includes such a next frame notice for this PS receiver.

26. The system of claim 24 wherein the PSAD analyzer is further configured to transmit the indication of length of said uplink frame to the PS transmitter during a scheduled uplink transmission period.

27. The system of claim 24 wherein the next frame notice indicates whether a ULT Start Offset and a ULT Duration in the PSAD for uplink transmission by the PS receiver describe the uplink transmission of said indication of length of said uplink frame.

28. The system of claim 22 wherein the PSAD constructor is further configured to include a pre-specified uplink transmission duration in the PSAD for a PS receiver, to notify that PS receiver to provide an indication of the length of a subsequent uplink frame for uplink transmission from that PS receiver to the PS transmitter.

29. The system of claim 28 wherein the PSAD analyzer is further configured to check for a pre-specified uplink transmission duration in the PSAD for this PS receiver and provide the uplink transmission information if the PSAD includes such a pre-specified uplink transmission duration for this PS receiver.

30. The system of claim 29 wherein the PSAD analyzer is further configured to provide said uplink transmission information in a control frame to the PS transmitter.

31. The system of claim 30 wherein said pre-specified uplink transmission duration indicates a pre-specified length of said control frame length of 22 bytes.

32. The system of claim 31 wherein said pre-specified length is 22 bytes.

33. The system of claim 18 wherein the wireless network comprises a WLAN.

34. The system of claim 18 wherein the transmitter comprises an access point and each receiver comprises a station.

35. The system of claim 18 wherein the communication system comprises a wireless personal area network.

36. The system of claim 29 wherein the communication system comprises a cellular network.

37. A power saving (PS) wireless transmitter for communication with at least one PS wireless receiver, comprising:
a scheduler that is configured to determine a power saving schedule of transmission opportunities for communication between a PS transmitter and at least one PS receiver over a shared channel, wherein the schedule includes corresponding durations for uplink transmissions of frames from each PS receiver to the PS transmitter;
a Power Saving Aggregation Descriptor (PSAD) constructor that is configured to construct a PSAD frame containing said schedule; and
a transmission module that is configured to transmit the PSAD frame, thereby initiating a PSAD sequence for communication between the PS transmitter and each PS receiver.

38. The transmitter of claim 37 wherein the scheduler is further configured to:
determine a DL schedule for DLT from the PS transmitter to each PS receiver;
determine an UL schedule for ULT from each PS receiver to the PS transmitter, wherein the uplink schedule includes precise durations for uplink transmissions of variable size frames from each PS receiver to the PS transmitter.

39. The transmitter of claim 37 wherein the scheduler is further configured to determine a power saving schedule that partitions downlink transmissions from the PS transmitter to each PS receiver and non-PS receivers into different PSAD sequences, thereby enabling each PS receiver to enter a power saving cycle during scheduled transmissions for non-PS receivers.

40. The transmitter of claim 37 wherein the schedule enables each PS receiver to enter a power saving cycle if no transmissions are scheduled for that PS receiver.

41. The transmitter of claim 38 wherein the scheduler is further configured to schedule a precise duration for uplink transmission of an uplink frame from the PS receiver in a subsequent PSAD sequence, based on indication of the length of said uplink frame from the PS receiver.

42. The transmitter of claim 41 wherein the PSAD constructor is further configured to include a next frame notice in the PSAD for a PS receiver, to notify that PS receiver to provide an indication of the length of a subsequent uplink frame for uplink transmission from that PS receiver to the PS transmitter.

43. The transmitter of claim 42 wherein the next frame notice indicates whether an ULT Start Offset and an ULT Duration in the PSAD for uplink transmission by the PS receiver describe the uplink transmission of said indication of length of said uplink frame.

44. The transmitter of claim 41 wherein the PSAD constructor is further configured to include a pre-specified uplink transmission duration in the PSAD for a PS receiver, to notify that PS receiver to provide an indication of the length of a subsequent uplink frame for uplink transmission from that PS receiver to the PS transmitter

45. The transmitter of claim 44 wherein said pre-specified uplink transmission duration indicates a pre-specified length of said control frame length of 22 bytes.

46. The transmitter of claim 45 wherein said pre-specified length is 22 bytes.

47. A power saving (PS) wireless receiver, comprising:
a receiving module that is configured to receive a Power Saving Aggregation Descriptor (PSAD) from a PS transmitter, the PSAD including a power saving schedule of transmission opportunities for communication between the PS transmitter and at least one PS receiver over a shared channel, wherein the schedule includes corresponding durations for uplink transmissions of frames from each PS receiver to the PS transmitter; and
a PSAD analyzer that is configured to analyze the schedule in the PSAD, and if the received PSAD does not specify a schedule for this receiving PS receiver, then enter the PS receiver into a power saving cycle, otherwise communicate with the PS transmitter according to a corresponding schedule in the PSAD.

48. The receiver of claim 47 wherein the schedule in the PSAD comprises:
a DL schedule for DLT from the PS transmitter to each PS receiver; and
an UL schedule for ULT from each PS receiver to the PS transmitter, wherein the uplink schedule includes precise durations for uplink transmissions of variable size frames from each PS receiver to the PS transmitter.

49. The receiver of claim 47 wherein:
the schedule partitions downlink transmissions from the PS transmitter to each PS receiver and each non-PS receiver into different PSAD sequences;
a PSAD analyzer is further configured to enter a power saving cycle during scheduled transmissions for non-PS receivers.

50. The receiver of claim 47 wherein the PSAD analyzer is further configured to analyze the schedule in the PSAD and provide uplink transmission information to the PS transmitter by:
determining an indication of the length of an uplink frame for a next uplink transmission from the PS receiver to the PS transmitter; and
transmitting the indication of length of said uplink frame to the PS transmitter.

51. The receiver of claim 50 wherein the PSAD analyzer is further configured to check for a next frame notice in the received PSAD, for this PS receiver, and provide uplink transmission information to the PS transmitter if the PSAD includes such a next frame notice for this PS receiver.

52. The receiver of claim 50 wherein the PSAD analyzer is further configured to transmit the indication of length of said uplink frame to the PS transmitter during a scheduled uplink transmission period.

53. The receiver of claim 51 wherein the next frame notice indicates whether an ULT Start Offset and an ULT Duration in the PSAD for uplink transmission by the PS receiver describe the uplink transmission of said indication of length of said uplink frame.

54. The receiver of claim 50 wherein the PSAD analyzer is further configured to provide said uplink transmission information in a control frame to the PS transmitter.

55. The receiver of claim 50 wherein the PSAD analyzer is further configured to check for a pre-specified uplink transmission duration in the PSAD for this PS receiver and provide the uplink transmission information if the PSAD includes such a pre-specified uplink transmission duration for this PS receiver.

56. The receiver of claim 55 wherein said pre-specified uplink transmission duration indicates a pre-specified length of said control frame length of 22 bytes.

57. The receiver of claim 56 wherein said pre-specified length is 22 bytes.
